(19) United States
(12) Patent Application Publication
(10) Pub. No.: US 2010/0057304 A1
(43) Pub. Date: Mar. 4, 2010

(54) Measuring system and measuring method for detecting at least one frequency independent electrical quantity

(75) Inventor: Marcus Kandler, Florssbachtal (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/591,076

(22) Filed: Nov. 6, 2009

Related U.S. Application Data
(63) Continuation of application No. PCT/EP2008/055716, filed on May 8, 2008.

(30) Foreign Application Priority Data
May 9, 2007 (DE) 10 2007 022 463.1

(51) Int. Cl. G06F 17/00

(52) U.S. Cl. 701/47

(57) ABSTRACT

A measuring system is provided. The measuring system comprising at least a first measuring means for detecting at least one frequency-independent electrical quantity and an evaluation unit for detecting the temporal behaviour of the frequency-independent electrical quantity. The evaluation unit automatically generates from the detection of the temporal course of the frequency-independent electrical quantity a signal that is at least partially equivalent to a frequency-dependent signal. Furthermore a measuring method is provided, in which at least a first measuring means detects at least a frequency-independent electrical quantity and an evaluation unit detects the temporal behaviour of the frequency-independent quantity. The evaluation unit automatically generates a signal from the detection of the temporal course of the frequency-independent electrical quantity, which signal is at least partially equivalent to a frequency-dependent quantity.

### CROSS-REFERENCE TO RELATED PATENT APPLICATIONS

This application is a Continuation of International Application No. PCT/EP2008/055716, filed on May 8, 2008, which was published in German on Nov. 20, 2008 as WO 2008/138870 A1. The foregoing International Application is incorporated herein by reference in its entirety.

### BACKGROUND

The present application relates to a measuring system and a measuring method, particularly for a motor vehicle.

Measuring methods are known from the state of the art which usually rely on the detection of frequency-dependent electrical quantities in order to detect different states. On a regular basis voltages, currents, amount of charges, and capacities or other electrical or electromagnetical quantities are measured depending on an applied frequency in order to be able to make statements about a change in state within a system to be monitored by means of their change or value with respect to a reference value or by means of their courses.

Such measuring methods or measuring systems are usually employed also in the field of seat occupation detection in a motor vehicle. Thus, U.S. Pat. No. 6,563,231 B1 amongst others describes a vehicle occupant sensor whose electrical field sensor comprises several first electrodes that can be arranged in a vehicle seat and at least one second electrode. By means of a measuring circuit that is connected to the first and the second electrode, the level of a capacity between a vehicle occupant on a motor vehicle seat and a grounding of the circuit can be controlled according to a disclosed embodiment. For this, the measuring circuit generates a signal depending on characteristics of an object adjacent to the electrical field sensor, which characteristics affect the electrical field. Therewith, not only the seat occupation of a motor vehicle seat shall be detected, but it shall also be detected whether the vehicle occupant occupying the motor vehicle is within a risk area. If this is the case, a deactivation of the safety systems, particularly the airbags, is necessary in order to minimize the risk of injury in case of a crash.

In accordance with U.S. Pat. No. 6,563,231 B1 and the associated family members e.g. U.S. Pat. No. 7,180,306 B2, U.S. Pat. No. 6,825,765 B2, U.S. Pat. No. 6,598,900 B2, U.S. Pat. No. 6,577,023 B1, U.S. Pat. No. 6,563,231 B1, U.S. Pat. No. 6,520,535 B1, U.S. Pat. No. 6,517,106 B1, U.S. Pat. No. 6,445,294 B1, U.S. Pat. No. 6,392,542, U.S. Pat. No. 6,378,900 B1, U.S. Pat. No. 6,283,504 B1 and U.S. Pat. No. 5,964,478 a seat occupation detection for a motor vehicle seat depending on a frequency depending quantity is respectively described. The basis is always the influence of an electrical field that is applied to an electrode and is generated by means of an application of a frequency-dependent electrical quantity, for example an oscillating current. An object to be detected affects the electrical field, i.e. it changes for example the capacity of the electrode relative to a ground or a reference potential. Thus, a frequency-dependent signal or a frequency dependent quantity is applied to the electrode and detected at the same time, so that the change of said signal quantity can be assigned to a defined change in state within the electrical field (for example a seat occupation).

Also U.S. Pat. No. 6,609,055 B2 describes a vehicle occupant detection system that judges about the occupation situation of a vehicle seat and therewith about the activation or deactivation of safety systems by means of logical combinations of several capacity values measured in this way and of weight values determined via weight sensors.

Thus, essential to all these measuring methods or measuring systems is the generation of a frequency-dependent signal in order to determine on this basis the seat occupation or the kind of seat occupation and eventually to additionally draw conclusions about the posture and figure of a vehicle occupant.

Such a measuring method or measuring system becomes problematical in case a so far clear allocation of the generated signals to a defined state or a defined change in state is not possible anymore within the system to be monitored due to one or several modifications.

For example, in case of the already mentioned measuring method or measuring systems for detecting a motor vehicle seat occupation, the installation of a child seat according to the ISOFIX-standard is such a modification. Here, ISOFIX is meant to be a special form of a secure fastening of child seats or in general child restraint systems in vehicles. Via a standardized plug connection, the child seat or the child restraint system is firmly connected to the body of the motor vehicle or to the seat frame of the motor vehicle seat. In this way, on the one hand, the risk of false operations is reduced and the protection effect is improved.

In case an ISOFIX compatible child seat is used, the latter is connected via its connection to the body or to the seat frame of the motor vehicle seat in an electrically conducting manner, and thus eventually also grounded. The mentioned measuring principles however, measure for instance capacities of an electrode relative to a ground or earth and distinguish a child seat arranged on the motor vehicle seat from a person by means of a lower (capacitive) influence on the electrical field. Also, usually a reactive and a resistive component of an impedance between a sensor and a ground or earth is measured and afterwards a decision is made using the real and imaginary parts of the current whether one deals with a person occupying the vehicle seat or a child seat. An ISOFIX child seat that is connected to the earth or grounded can however not be distinguished from a person by the corresponding measuring system, since it forms a grounding shield that completely shields the sensing fields, i.e. the frequency-dependent quantity (e.g. a sinusoidal field). The signals corresponding to an ISOFIX child seat and a person generated by the measuring system are nearly equal and therefore do not allow for an error-free or clear allocation of the generated signal to a certain kind of seat occupation.

### SUMMARY

Hence, the problem underlying the invention is to create an improved measuring system and an improved measuring method, particularly for a motor vehicle.

According to an exemplary embodiment a measuring system is provided having at least one first measuring means for detecting at least one frequency-independent electrical quantity, particularly a charge, an evaluation unit for detecting the temporal behaviour of the frequency independent electrical quantity (e.g. charging and discharging times of a capacitor), wherein the evaluation unit converts the temporal course of the frequency-independent electrical quantity into a signal particularly characterizing a state of a connection between two components (e.g. between a child seat and a seat of the motor vehicle), wherein said signal is at least partially equivalent to a frequency-dependent signal. I.e., statements about the behaviour of the frequency dependent quantity are possible by means of the measuring system.

Therefore, also statements about the behaviour of at least one frequency-dependent quantity or also several frequency-dependent quantities can be made, which were not possible formerly due to a pure frequency-dependent measurement. For example, by detecting the temporal course of the frequency-independent quantity and at the same time by detecting the frequency-dependent quantity, the behaviour of the frequency-dependent quantity upon a change in state of the measured or monitored system can be analysed. For example, the reaction or the absence of a reaction of the frequency-dependent quantity can be clearly timed and evaluated, in case a change in state was merely detected or determined, respectively, by means of an equivalent signal of the frequency-independent quantity.

In this respect it is again referred to the already mentioned child seats, which can be fastened to a motor vehicle seat (e.g. back seat) by means of latching fasteners, for instance equipped with a so called ISOFIX-System, and cannot be distinguished from persons usually. As described initially, this is caused by the fact, that such a child seat being in a state in which it is fastened to a motor vehicle seat, is connected to the grounded seat frame of the motor vehicle seat via the latching fastener in an electrically conducting manner. Therewith, a grounding shield is formed by the child seat, which completely shields the sensing field, i.e. the frequency-dependent quantity (e.g. a sinusoidal field).

An exemplary embodiment now allows for a detection of the occupation of the seat by a child seat of the aforementioned kind in particular by means of a frequency-independent quantity. Thereby, a signal on the basis of a temporal behaviour of a frequency-independent quantity, for example a current or an amount of charge is at least partially equivalent to a signal of a frequency-dependent quantity that is responsible for the activation and/or adjustment of security relevant vehicle systems.

Here, in an exemplary embodiment, an electrically conducting part of the latching fastener (e.g. ISOFIX-bail), which stays at the seat, is used as an electrode. This electrode can take up a charge within a certain time and can release said charge within a certain time (discharging). The charging or discharging time of the free part of the latching fastener residing at the seat is taken as a reference value. Thus, the child seat is in a state in which it is not connected to the seat of the motor vehicle as intended.

In case a (also electrically conducting) first part of the latching fastener residing at the child seat is connected to a second part of the latching fastener residing at the seat, the capacity of the electrode is increased and the charging or discharging time of said electrode changes correspondingly. This change of the charging or discharging time with respect to the reference value can be measured. Thus, by means of the disclosed measuring system it can be for example clearly differentiated, whether a child seat is fastened to a seat of the motor vehicle as intended or not. Thereby, the first part of the latching fastener can be of course connected to further parts of the child seat or eventually to the whole child seat or frame of the child seat in an electrically conducting manner.

It is crucial that the latching fastener comprises two electrically conducting parts or components—one part resides on the child seat, the other part on the seat of the motor vehicle—so that closed latching fastener (both parts or components are connected to each other in an electrically conducting manner) comprises a higher capacity than the part residing on the motor vehicle seat on its own. Such a latching fastener is for example provided by a known ISOFIX-fastener.

It is regarded as advantageous, independent from the concrete embodiment as a measuring system for determining or detecting a seat occupation, that the first measuring means comprises a capacitor and/or a coil.

At hand, it is understood that a measuring means is any kind of electrical or electronic circuit arrangement or electrical or electronic part, which is able to detect an electrical quantity and/or to store or forward it to an evaluation unit or for example to a control device.

Furthermore, exemplary, a current, a voltage and/or a charge is measured as a frequency-independent electrical quantity, since for example a change in these quantities with respect to a reference value or a change of these quantities with respect to their temporal behaviour can be detected in a simple manner. Therefore, a nearly unique allocation of a change or modification affecting the behaviour of the frequency-independent electrical quantity can be detected.

Therefore, in particular, it is regarded as advantageous in case the temporal behaviour of the frequency-independent quantity detected by the evaluation unit is the behaviour of a charging and/or discharging process.

According to the above-mentioned exemplary embodiment having an ISOFIX child seat, the at least one measuring means and the at least one evaluation unit is preferably arranged in a vehicle. Here, the measuring system is of course not limited to the mentioned embodiment, but can also be used in connection with other vehicle systems or measuring systems.

According to the above-stated embodiment of the measuring system in relation to an ISOFIX child seat, it is basically regarded as advantageous that a first electrode of a capacitor is part of a first component, wherein a second electrode of a second component can be coupled to the first electrode.

Furthermore, then, from the dynamics of the charging and/or discharging of the capacitor, a signal about the mechanical connection state between the first component and the second component can be generated. Thereby, said connection can be any form of a component connection, also a form fit, force fit or an adhesive bond. A signal characterizing the component connection would then be e.g. equivalent to a signal generated in dependence on a frequency-dependent quantity, which also characterizes a state of a component connection. It is also conceivable that the equivalent frequency-dependently generated signal is interpreted as being conformed by a measuring system or an electronic control device, respectively, although it does not reflect the state of the component connection. For this, again, the embodiment having an ISOFIX child seat could be stated in case of which the detected connection of both parts of the latching fastener generates a signal, which, advantageously, is completely equivalent to a frequency-dependently generated signal, which “reports” to the measuring system, that a child seat is residing on the motor vehicle seat. At least, a child seat not equipped with the ISOFIX standard can be detected by means of a frequency-dependent quantity.

Accordingly, it is preferred that at least one component, e.g. a child seat as a second component, is part of a latching fastener, so that at least one signal of the evaluation unit can be utilized for detecting a connection. Thereby, the latching fastener of the ISOFIX system is regarded as such a latch.

Thus, it is advantageous in case a coupling to at least one measuring means for detecting a frequency-dependent quantity is possible, so as to improve the integration and to combine advantages of known systems with the disclosed measuring system.

Here, then also a coupling with an occupant protection system, particularly an airbag system in a vehicle, is targeted, in order to minimize the risk of injury due to false or insufficiently detected seat occupation states.

With regard to the problem described initially arising due to the grounding of an ISOFIX child seat, it would be in principle also possible to decouple the latching connection or the so called ISOFIX bail, in order to prevent the grounding. For this, insulations having thicknesses in the cm-range would be necessary, which are neither efficient nor can be realized in a constructively reasonable manner. However, concerning the measuring system and its application having a child seat it is also preferred, that the child seat comprises (at least) a thin insulation layer, i.e. a few millimetres thick.

Particularly, an inventive idea disclosed herein includes combining the disclosed system with a measuring system, that generates a signal by means of a frequency-dependent quantity, to which a specific or defined state or a corresponding change in state can be associated. For example, this means a measuring system that, as already stated, determines the occupation of a vehicle seat.

Correspondingly, a disclosed method provides for detecting at least one frequency-independent electrical quantity by means of at least one first measuring means, to detect the temporal behaviour of the frequency-independent electrical quantity by means of an evaluation unit, wherein the evaluation unit automatically generates a signal on the basis of the temporal course of the frequency-independent electrical quantity which is at least partially equivalent to a frequency-dependent signal.

In this way, the method allows for counteracting a frequency dependency of a measuring system by means of generating a signal via a frequency-independent quantity, that at least partially corresponds to a frequency-dependent signal. A measuring method conducted therefore allows for the detection of a defined state or a defined change in state within a monitored or measured system by means of a frequency-dependent as well as a frequency-independent electrical quantity.

Concerning the use of the measuring system as well as concerning the application of the measuring method, a plurality of measuring means can be employed or a plurality of electrical frequency-independent quantity can be detected and evaluated. Also, a logical combination can be provided within the evaluation unit, so that the signal generated by the evaluation unit is generated not until the temporal courses of all or several of the frequency-independent electrical quantities indicate a change in state within the measured (monitored) system. For example, an evaluation unit at a motor vehicle seat is provided for generating a signal not until several ISOFIX latching bails of a child seat are engaged with ISOFIX latching hooks of the motor vehicle seat.

### BRIEF DESCRIPTION OF THE DRAWINGS

Further details and advantages of the invention are made clear by means of the following description of embodiments with reference to the Figures.

FIG. 1 shows a perspective view of a motor vehicle seat having a latching fastener for fastening a child seat to the motor vehicle seat, particularly a back seat.

FIG. 2 shows a schematical, cross sectional view of a motor vehicle seat of the kind shown in FIG. 1 having a measuring system.

FIG. 3 shows a perspective view of a region of a motor vehicle seat of the kind shown in FIGS. 1 and 2 having a latching fastener (ISOFIX) for fastening a child seat to the motor vehicle seat (the latching principle).

FIG. 4 shows a schematical, partly cross sectional view of the latching fastener shown in FIG. 3.

FIG. 5 shows a block diagram of a measuring system for detection of the occupation of a seat of a motor vehicle. Thereby, “I” and “Q” are the in-phase-idle current components of the current sent to the sensor. These are used for classification in case of wet seats.

FIG. 6 shows a further block diagram of a measuring system for detection of the occupation of a motor vehicle seat, in conjunction with a grounded motor vehicle seat.

FIG. 7 shows a schematical, cross sectional view of a motor vehicle seat with an occupant occupying the seat.

FIG. 8 shows a schematical view of an arrangement for detection of the presence of a person by means of capacity measurements.

FIG. 9 shows a block diagram of a measuring system for determining the occupation of a motor vehicle seat (e.g. by a child seat).

### DETAILED DESCRIPTION

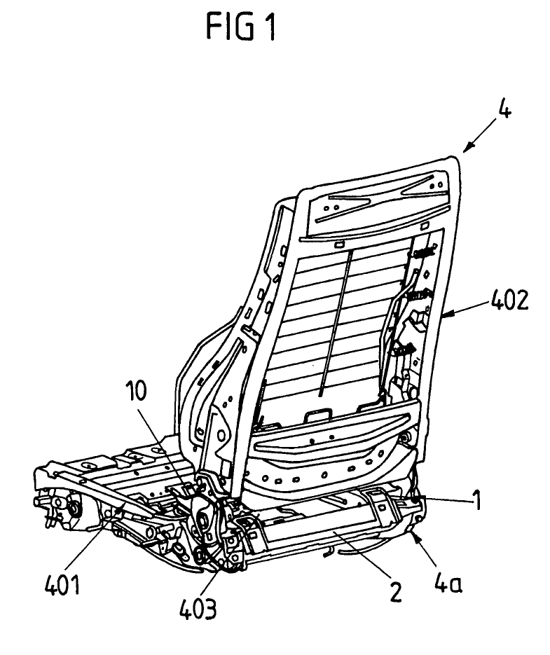

FIG. 1 shows in a perspective rear view a seat frame 4a of a motor vehicle seat 4 consisting of a seat part 401 and a backrest 402 which inter alia are hinged to one another in a known manner via a seat adjusting mechanism 10. In order to assure that the backrest 402 can be pivoted with respect to the seat part 401 also in an upholstered state in the direction of the latter, both of the stated parts of the motor vehicle seat 4 are arranged at a distance in a region 403 between the seat adjusting mechanism 10 laterally connecting both parts. In this region 403 which is thus in a built-in state facing the rear side of a motor vehicle, an ISOFIX latching bail 2 is provided at the seat part 401 or the seat frame 4, respectively. On the ISOFIX latching bail 2 two ISOFIX latching hooks 1 are mounted or integrally formed with said bail 2 at a distance with respect to each other and symmetrically with respect to a seat longitudinal axis. Said hooks provide for a connection to the seat frame 4a of the motor vehicle seat 4 or are parts of the seat frame 4a.

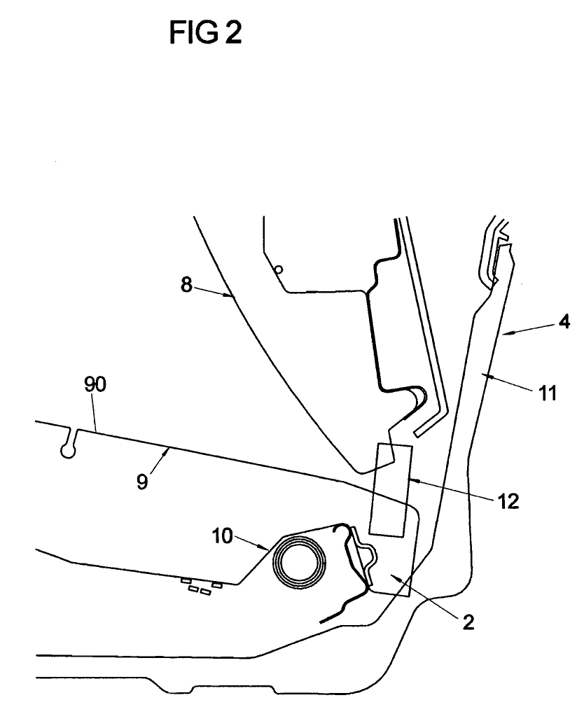

In the cross sectional side view of FIG. 2, the motor vehicle seat 4 of FIG. 1 is shown having a cushioning. The seat part 401 is equipped with a cushion part 9 in order to provide a cushioned seating area 90 and the region of the backrest 402 facing the seat part 401 is provided with a cushion part 8. In this cross sectional view also a rigid rear wall 11 of the backrest 402 is apparent, which is provided on a side of the backrest 402 facing away from the seating area 90 of the cushioned seat part 401.

In the free region 403 between the backrest 402 and the seat part 401 a so called elo-box 12, i.e. a computer or evaluation unit, is arranged which is in an operative connection to the ISOFIX bail 2. Of course, it may also be in a direct connection to the ISOFIX latching hooks 1. It is only important that the elo-Box 12 is coupled to the ISOFIX components of the seat frame 4a in a way that it is possible to detect an engagement of an ISOFIX latching arm with an ISOFIX latching hook 1. This means in this relation, that it can detect and evaluate a stressed charging or discharging process or its temporal course of the ISOFIX latching bail 2 regarded as an electrode or of the ISOFIX latching hook 1, respectively.

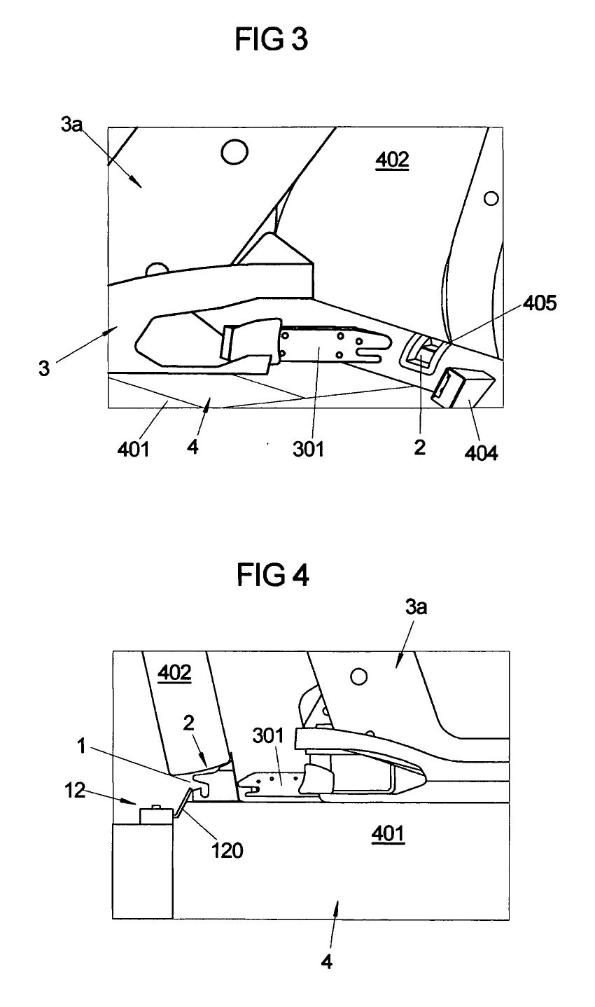

By means of FIG. 3, the functional principle of the ISOFIX child seat system is clarified in a perspective view. Here, the motor vehicle seat 4 is a back seat of a motor vehicle and provides for an opening 405 between the cushioned seat part 401 and the cushioned backrest 402, which opening 405 is arranged adjacent a belt buckle receptacle 405 for insertion of a buckle tongue of a seat belt. Through this opening 405 an ISOFIX latching bail 301 of a child seat 3 is inserted, which is arranged on a child seat frame 3a of the child seat 3. The ISOFIX latching arm 301 therefore resides at a rear side of the child seat 3 facing the backrest 402 and extends substantially perpendicular from the latter in the direction of the backrest 402.

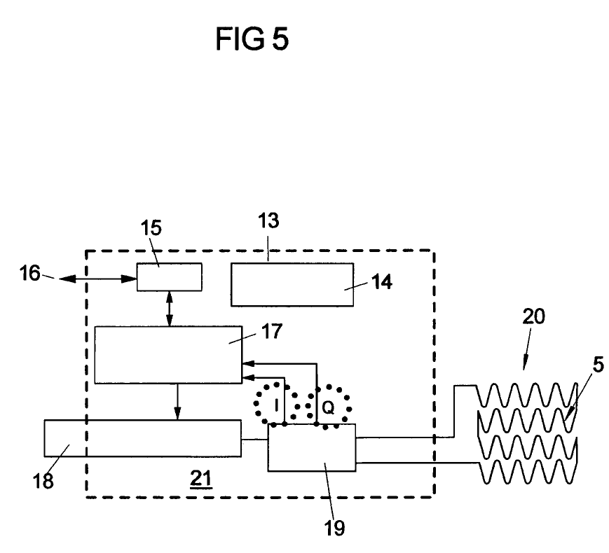

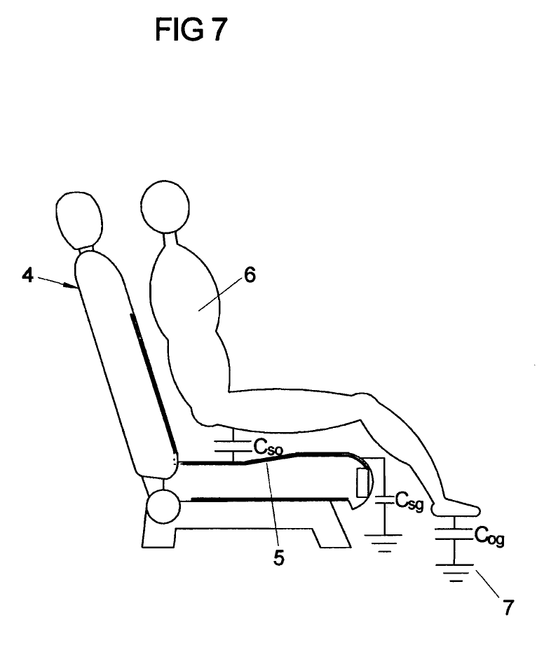

As shown in the cross sectional side view of FIG. 4, the ISOFIX latching arm 301 engages with the ISOFIX latching hook 1 of the ISOFIX latching bail 2 on the motor vehicle seat after insertion into the opening 405 between the backrest 402 and the seat part 401. In this way, the child seat 3 or the child seat frame 3a is firmly connected to the seat frame 4a of the motor vehicle seat 4. In order to assure a sufficiently stable connection, the ISOFIX latching arm 301 as well as the ISOFIX latching hook 1 is made of metal. In order to have the child seat frame 3a connected to the seat frame 1a of the motor vehicle seat 1 in an electrically conducting manner, both frames have the same potential or in case of a grounded seat frame 4a also the child seat frame 3a is grounded. The measuring principles presented by means of FIGS. 5-8 in the following therefore do not allow to distinguish between the child seat 3 connected to the seat frame 4a and a person occupying the motor vehicle seat 4 in dependency of a frequency-dependent potential or capacity measurement. A clear or error-free allocation of a signal that is generated by means of a frequency-dependent quantity—on the basis of a generated electrical field—and triggers the activation or deactivation of a safety system of a motor vehicle is not possible any longer.

For this reason, corresponding to FIG. 4, it is provided that the ISOFIX latching bail 2 or only the ISOFIX latching hook 1 are used as a first electrode of a capacitor in the sense of a measuring means, which in the unconnected state, i.e. without connection to a ISOFIX child seat 3, are acted upon with a frequency-independent quantity, so as to determine a reference value. Thus, presently, for example the ISOFIX latching bail 2 or the ISOFIX latching hook 1 can be repeatedly charged or discharged as a first electrode of a capacitor and the temporal course of the charging or discharging process is determined as a reference. For this, the ISOFIX latching hook 1 is coupled to an evaluation unit in the form of the elo-box 12 via a contact 120 or a conductor element, which determines and evaluates said temporal course. Thereby, the charging or discharging process can be conducted continually or only in a certain time interval, e.g. after the opening of the motor vehicle in a predetermined period, and/or with a given frequency of occurrence.

In case the ISOFIX latching arm 301 of the child seat 3 is now connected to the ISOFIX latching hook 1 in a electrically conducting manner, the latter forms a second electrode of the capacitor and the temporal course of the charging or discharging process is changed. The capacity of the ISOFIX latching hook 1 considered as capacitor, eventually in combination with the ISOFIX latching bail 2, has increased and the charging or discharging behaviour of the latter has changed detectably. The elo-box 12 detects the change resulting therefrom in the temporal course of the frequency-independent quantity, for example the charging or discharging current, and generates a signal that leads to the deactivation of the airbag system for example. Therewith, basically, the risk of injury of a child residing on the child seat 3 due to an airbag deploying in the case of a crash shall be reduced. The corresponding signal of the elo-box 12 is thereby equivalent to a signal that is generated by a frequency-dependent detection or measuring device for the seat occupation, so as to determine the occupation of the motor vehicle seat 4 by a child seat, for example that is not equipped with ISOFIX.

Concerning the detection of the temporal course of the charging or discharging process, it is also possible that the contact 120 of the evaluation unit, according to FIG. 4 the elo-box 12, is not permanently connected to the ISOFIX latching hook 1 or to the ISOFIX latching bail 2. Instead, due to the insertion of the ISOFIX latching arm 301 of the child seat 3, the contact 120 can be separated for example from the ISOFIX latching hook 1 and can be directly coupled to the ISOFIX latching arm 301. For this, the contact can be for example formed as a pretensioned conducting spring or can be supported in a resilient manner. An end of the ISOFIX latching arm 301 inserted through the opening 405 could then change the position of the contact 120 while surmounting a spring force, for example displace it in the direction of the insertion of the ISOFIX latching arm 301. Accompanying, the coupling of the contact 120 to the ISOFIX latching hook 1 could be separated and at the same time an electrically conducting connection of the contact 120 to the ISOFIX latching arm 301 could be realized. Accordingly, also with this, a change in the temporal course, e.g. of the charging or discharging current feed via the contact 120 could be detected.

It is substantial that the measuring systems shown in the FIGS. 5-7 for determining the occupation of a motor vehicle seat 4 by means of a frequency-dependent quantity are generalized, so that also an occupation with an ISOFIX child seat 3 is clearly detectable, so as to deactivate or prevent the activation of passive or active safety systems that pose a danger to the occupant.

So, FIG. 5 shows as a block diagram a control system 21 having an energy supply 14 that is assured by means of a battery supply voltage V_{Batterie}. Furthermore, the control system 21 comprises a connection to a cable harness 16 of the seat, e.g. for connecting to a passive or active security system. The connection to the cable harness 16 is provided via a CAN-BUS 15, i.e. a usual communication system in the automobile sector for making connection to a control device. The CAN-BUS 15 is coupled to a microprocessor 17, which in turn controls a sinusoidal wave generator 18 and detection current measurement 19 connected thereto.

To the detection current measurement 19 a detection unit 20 as a measuring means having a sensing or detection element 5, e.g. an electrical sensor or heating mat, is connected outside the control system 21. Upon feeding the detection unit 20 with a sinusoidal signal, e.g. a 12 kHz harmonic sinusoidal signal, a current I and a charge Q can be measured which are evaluated by the microprocessor 17.

The detection elements 5 or sensors, which eventually can be regarded independently from the detection unit 20 as measuring means, usually reside beneath the seating area 90 in the cushion part 9 of the seat part 401 and in the backrest 402. By feeding with an oscillating signal, the detection element 5 generates an electrical field. Advantageously, the detection element 5 is designed as a capacitive sensor, so that a capacity of a first electrode of the detection element 5 with respect to a ground, presently e.g. the reference potential of the seat frame 4a or a vehicle floor 7, can be measured. By means of an object or a person on the motor vehicle seat 4 the electrical field and therewith the measured capacity are influenced. From this influence of the frequency-dependent quantity a seat occupation or the kind of a seat occupation can then be detected. So, the detected capacity due to a vehicle occupant 6 residing on the motor vehicle seat 4 is in the usual case clearly increased and due to a child seat without ISOFIX system the capacity is only insignificantly or hardly increased. An increase of this detected, frequency-dependent quantity correspondingly leads for example to a generation of a signal that activates the safety systems of the motor vehicle for the motor vehicle seat 4.

The wetness of a motor vehicle seat 4 or the cushion parts 8 and 9 into which a detection element 5 resides, can have a significant effect on the capacity of the detection element 5 regarding a reference potential or a ground. So, a conducting liquid on the detection element 5 increases the detected capacity. Therefore, for a wet seat the reactive and resistive component of the impedance between the detection element 5 and a ground, in general the earth, is additionally measured on a regular basis and by using the real and imaginary parts of the current a distinction with respect to the kind of the seat occupation in case of wet seat is made. So, in FIG. 5 the values I and Q detected at the microprocessor 17 are the in-phase and idle current components of the feeding current sent to the detection element 5, which are used for classifying the seat occupation in case of humid or wet seats.

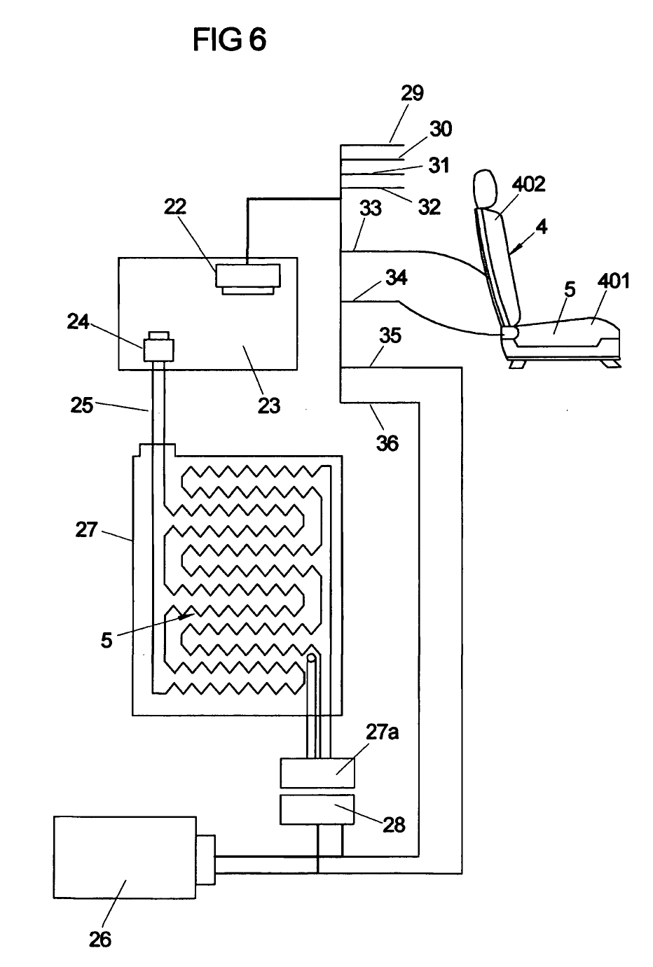

An embodiment of a measuring system from the state of the art for detecting the occupation of a motor vehicle seat 4 is shown in the block diagram of FIG. 6. Thereby, the detection takes place in conjunction with a grounded motor vehicle seat 4 and a heating mat located therein in the seat part 401 as a detection element 5 or detection unit.

Therein, one can infer that the backrest 402 and the seat part 401 are grounded via grounding conductors 33 or 34, so as to produce a defined system. Furthermore, an electronic control device 23, here via a 8-pin-connection to V_{Batterie}, is connected to a ground 30, a first CAN-BUS 31, a second CAN-BUS 32, the grounding conductors 33 and 34 of the motor vehicle seat 4, first and second grounding conductors 35 and 36 for a heating device 27. Said eight connections or connection conductors lead also to an electronic control device 26 for the heating device 27 and comprise a branching to a cable harness connection piece 28. The cable harness connection piece 28 provides for a connection to a connection piece 27a of the heating device 27. The heating device 27 comprises then the detection element 5 formed as a sensor or heating mat and comprises a permanent connection 25 between the electronic control device 23 and the heating mat. Thereby, the permanent connection 25 is realized via a two-core connection 24 to the electronic control device 23.

By means of such an arrangement and circuitry of detection units or the detection element 5, respectively, in particular a capacity C_{og} between a person occupying the motor vehicle seat 4 as intended, a vehicle occupant 6, and a vehicle bottom 7 as well as the capacity C_{sg} between the detection element 5 (sensor) and the vehicle floor 7 and the capacity Cₛₒ between the detection element 5 (sensor) and the vehicle occupant 6 can be detected and used for determining the occupation of the motor vehicle seat 4.

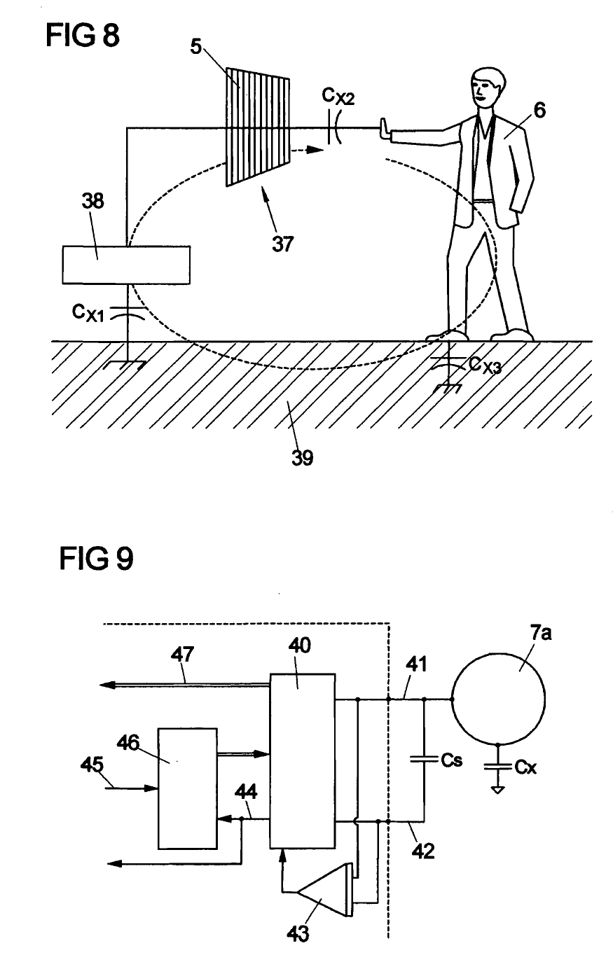

Such an arrangement for the so called capacitive detection of the presence of a person 6 is also shown in FIG. 8. Therein, also the Rules of Kirchhoff being also applied in this connection are schematically clarified. So, also the presented measuring system with the capacitive detection element 5 obeys the natural law that the current of the generated electrical field of the detection element 5 must form a part of a closed circuit. So, the sensor unit 38 is not only connected to a detection electrode 37 which the detection element 5 comprises, but is also capacitively connected via Cₓ₁ to the neighbouring surrounding 39. Also, the person 6 to be detected by means of the detection electrode 37 via Cₓ₂ in a capacitive manner also comprises a coupling to the surrounding 39 (Cₓ₃). In this way, an electrical circuit is formed, in case of which the ground of the detection electrode 37 or the detection element 5 and the person 6 to be detected are connected to each other.

This mandatory condition is also allowed for with the circuit of FIG. 6, in which the motor vehicle seat 4 or its backrest 402 and its seat part 401 must be grounded for a seat occupation detection.

Accordingly, the functionality of such a measuring system is disturbed, in case the child seat frame 3a is connected to the seat frame 4a of the motor vehicle seat 4 via the ISOFIX system and the metal in the child seat 3 is also on the same potential as the rest of the motor vehicle seat 4. A distinction between persons 6 and child seats 3 having ISOFIX systems is made impossible due to the fact that values generated by the measuring systems are equal (cf. FIGS. 6-8) or have the same size of I and Q (cf. FIG. 5).

A simple isolation does not suffice in order to decouple the ISOFIX latching bail 2 from the rest of the ground, since one does not deal with a “direct voltage” resistance” but with an impedance.

An analogue measuring method may be combined with a frequency-dependent measuring method, particularly of the kind shown in FIGS. 5-7, so as to detect ISOFIX child seats 3 in this particular preferred embodiment and then to deactivate or prevent the activation of passive or active security systems, which pose a danger to the occupant. Of course, therewith, also the detection of child seats is possible, which however does not comprise ISOFIX standard, but can however be also not clearly differentiated from a person by means of the described frequency-dependent measuring methods or systems due to comparable restrictions.

Furthermore, it is regarded as advantageous, in case the ISOFIX parts of the motor vehicle seat 4, e.g. the ISOFIX latching bail 2, comprise a simple (thin) insulation, so as to provide for a “direct voltage insulation” with respect to the seat frame 4a. Or in other words, the ISOFIX latching bail 2 serving as a sensor electrode comprises an insulation, which indeed would assure in case of an operation under direct voltage a sufficient separation of the ISOFIX latching bail 2 and the seat frame 4a which isolation is however clearly too small in order to provide for a complete electromagnetical decoupling in the presented case.

According to the already described measuring method, a capacitor is provided in the present embodiment, which is continuously charged and discharged. The charging and discharging times are used as a reference. The ISOFIX latching bail 2 is used as an electrode. The charging of this electrode having its geometrical characteristics takes a certain time like in case of a capacitor. This time is used (after it was subtracted from the reference time) in order to represent a “0” state. In case the area of the electrode is now increased by connecting the child seat 3, also said time is increased and it is detected that an ISOFIX child seat 3 was installed. Thus, a “1” state results.

FIG. 9 shows a block diagram for determining the characteristic frequency-dependent quantity of an electrode 7a (like for instance charging times and discharging times of the electrode 7a). The electrode 7a can be e.g. a part of a (ISOFIX-) latching fastener for a child seat 3, particularly a second part of the (ISOFIX-) latching fastener provided at the motor vehicle seat 4, e.g. the ISOFIX latching bail 2 or the ISOFIX latching hook 1. Correspondingly, the circuit shown in FIG. 9 could also be part of the evaluation unit or the elo-box 12 of the preceding FIGS. 1-4.

Due to a start directive 45 to a usual electronic signal sequence controller 46 (so called “burst-controller”) a capacitor or analog digital converter 40 switched using a one-ramp-method (single-slope) is controlled. By means of this capacitor the charging or discharging of the electrode 7a and a capacity Cs defined in dependence on the sensitivity is evaluated, which electrode is connected to the analog digital converter 40 via connection conductors 41 and 42. Thereby, the electrode comprises a capacitive grounding Cx. Via a charge amplifier 43 also connected to the connection conductors 41 and 42, the temporal course of the charging or discharging process is forwarded to the analog digital converter 40. The latter transmits on the one hand a reply 44 about the end of the charging or discharging process. On the other hand, it generates a signal 47 that reflects the actually detected state of the electrode 7a, thus for instance signalizes a “1” state in case of an increased capacity of the electrode 7a.

This signal 47 defines for example whether the child seat 3 is connected via its ISOFIX latching arm 301 to the ISOFIX latching bail 2 in an electrically conducting manner, so that the charging or discharging time of the electrode has changed, which now comprises the ISOFIX latching arm 301 and the ISOFIX latching hook 1 and eventually the ISOFIX latching bail 2. This change of the charging or discharging time is detectable for determining the occupation of the motor vehicle seat 4 by the ISOFIX child seat 3.

Independent from the things described so far, the application of the measuring method or measuring system is also possible in other application areas, in which frequency-dependent measuring values are determined so as to detect a certain state.

The priority application, German Patent Application 10 2007 022 463.1, filed May 9, 2007, including the specification, drawings, claims and abstract, is incorporated herein by reference in its entirety.

What is claimed is:

1. A measuring system, comprising:
a) at least one measuring means for detecting at least one frequency-independent electrical quantity;
b) an evaluation unit for detecting the temporal behaviour of the frequency-independent electrical quantity, wherein
c) the evaluation unit automatically generates from the detection of the temporal course of the frequency-independent electrical quantity a signal that is at least partially equivalent to a frequency-dependent signal.

2. The measuring system of claim 1, wherein the first measuring means comprises a capacitor and/or a coil.

3. The measuring system of to claim 1, wherein the frequency-independent electrical quantity is a current, a voltage and/or a charge.

4. The measuring system of claim 1, wherein the temporal behaviour of a charging and/or discharging process is detected by the evaluation unit.

5. The measuring system of claim 1, wherein the at least one measuring means and the at least one evaluation unit are arranged in a vehicle.

6. The measuring system of claim 1, wherein a first electrode of a capacitor is part of a first component, wherein a second electrode of a second component can be coupled to the first electrode.

7. The measuring system of claim 6, wherein a signal about the state of the mechanical connection between the first component and the second component can be generated from the dynamics of the charging and/or discharging of the capacitor.

8. The measuring system of claim 6, wherein the first electrode of the capacitor is coupled to a fastening bail of an ISOFIX child seat, and the second electrode of the capacitor is coupled to a child seat for the vehicle.

9. The measuring system of claims 6, wherein at least one component is part of a latch, so that at least one signal of the evaluation unit can be used for detecting a connection.

10. The measuring system of claim 1, further comprising a coupling to at least one measuring means for detecting a frequency dependent quantity.

11. The measuring system of claim 1, further comprising a coupling to an occupant protection system, particularly an airbag system in a vehicle.

12. A device for installation into a motor vehicle, wherein it can be coupled to a measuring system of claim 1.

13. The device of claim 12, wherein it is formed as a child seat for a vehicle.

14. The device of claim 13, wherein the child seat comprises a thin insulating layer.

15. A measuring method, comprising the steps of:
(a) detecting at least frequency-independent electrical quantity using a first measuring means;
(b) detecting the temporal behaviour of the frequency-independent electrical quantity using an evaluation unit detects, wherein
c) the evaluation unit automatically generates from the detection of the temporal course of the frequency-independent electrical quantity a signal that is at least partially equivalent to a frequency-dependent signal.
